(19) United States
(12) Patent Application Publication
(10) Pub. No.: US 2023/0351418 A1
(43) Pub. Date: Nov. 2, 2023

(54) BUSINESS OPPORTUNITY INFORMATION RECOMMENDATION SERVER AND METHOD THEREFOR

(71) Applicant: ENTERPRISE BLOCKCHAIN CO., LTD., Seoul (KR)

(72) Inventors: Jihyun LEE, Yongin-si (KR); Seonghyuck YOO, Seoul (KR); Jungjun KIM, Seoul (KR); Jinmo JUNG, Seoul (KR); Junsup LEE, Seoul (KR); Taeho GWAK, Seoul (KR)

(73) Assignee: ENTERPRISE BLOCKCHAIN CO., LTD., Seoul (KR)

(21) Appl. No.: 18/020,697

(22) PCT Filed: Aug. 13, 2021
(86) PCT No.: PCT/KR2021/010774

§ 371 Date: Feb. 10, 2023

(30) Foreign Application Priority Data
Aug. 18, 2020 (KR) 10-2020-01013330

(51) Int. Cl. G06Q 30/0201; G06N 5/048

(52) U.S. Cl. CPC G06Q 30/0201; G06N 5/048

(57) ABSTRACT

Disclosed are a business opportunity information recommendation server and a method therefor, the server comprising: a data acquisition unit for acquiring, on the basis of an external input, lead data, lead buyer data, and lead seller data, which are pieces of product- or service-related business opportunity information about a customer; a learning unit for generating, on the basis of the lead data, the lead buyer data, and the lead seller data, a learning model by being trained for deep learning; a prediction unit for predicting, on the basis of the learning model, the degree of association between a lead buyer and a lead, the degree indicating the purchase possibility of the predetermined lead buyer for each piece of lead data being sold; and a recommendation unit for generating a first lead recommendation list, which includes at least one piece of lead data being sold, arranged by the degree of association between the lead buyer and the lead with respect to the predetermined lead buyer.

### TECHNICAL FIELD

The present invention relates to a server for recommending business opportunity information and a method thereof. More particularly, the present invention relates to a server and a method for recommending sales opportunity information (lead) with a higher association, by predicting a degree of association between a predetermined lead buyer and the lead, indicating a purchasing possibility for each lead data on sale by the lead buyer, based on a learning model for deep learning lead data, lead buyer data, and lead seller data for the lead, the lead including the product or service-related sales opportunity information for customers.

### BACKGROUND ART

The recent transition to an untact society in which almost all aspects of daily life are performed in a non-face-to-face manner is accelerating due to the transition to the digital age and many concerns about disease infection due to viruses or the like.

Under such a situation, a salesperson will have limited opportunities to meet customers in face, and thus, it will take a lot of effort, time, and cost to obtain customers.

Therefore, a solution is required for sharing some business opportunity information from other salespersons who have previously obtained such business opportunity information (lead) for any purchasing needs of customers related to certain products/services or from the customers who want to purchase the products/services, and for promoting selling of the shared business opportunity information.

### DETAILED DESCRIPTION OF THE INVENTION

### Technical Problem

The present invention has been devised to cope with the above-described technical problems, and aims to substantially make up for various problems caused by limitations and disadvantages in the prior art. It is therefore an object of the present invention to provide a server and a method for recommending a lead with a higher association by predicting a degree of association between a predetermined lead buyer and the lead, indicating a purchasing possibility for each lead data on sale by the lead buyer, based on a learning model for deep learning the lead data, the lead buyer data, and the lead seller data for the lead, the lead including the product or service-related sales opportunity information for customers. Further, the present invention aims to provide a computer-readable recording medium in which a program for executing the method is recorded.

### Technical Solution

According to an embodiment of the present invention, a method for recommending business opportunity information comprises obtaining lead data, lead buyer (or purchaser) data, lead seller data, the lead including product or service-related business opportunity information for a customer, based on an external input; generating a learning model by deep learning based on the lead data, the lead buyer data, the lead seller data; based on the learning model, predicting a degree of association between the lead buyer and the lead, representing a purchasing possibility of a predetermined lead buyer for each lead data on sale; and generating a first lead recommendation list including at least one lead data on sale, being arranged based on the degree of association between the lead buyer and the lead for the predetermined lead buyer.

According to an embodiment of the present invention, the generating a learning model further includes generating a lead feature vector, a lead buyer feature vector, and a lead seller feature vector, including at least one feature vector representing each attribute value respectively, based on the lead data, the lead buyer data, and the lead seller data; and generating a learning model for learning a degree of association between the lead buyer and the lead, based on the lead feature vector, the lead buyer feature vector, and the lead seller feature vector.

According to an embodiment of the present invention, the step of generating a learning model further includes learning about at least one of a degree of lead seller association representing a similar sales pattern between the lead seller data and a degree of lead association representing a similar sales pattern between the lead data, based on the lead feature vector, the lead buyer feature vector, and the lead seller feature vector.

According to an embodiment of the present invention, the lead data includes information on at least one of lead type, detailed information for each lead type, desired lead amount, customer name, customer age, customer gender, customer marital status, customer address, customer phone number, desired contact time of customer, customer budget, level of customer’s purchasing intention, customer’s expected purchasing time, or lead seller information.

According to an embodiment of the present invention, the lead buyer data includes lead buyer profile data and lead buyer behavior data. The lead buyer profile data further includes information on at least one of a lead buyer’s name, photo, age, area of activity, field of expertise, field of sales qualification, field of interest, whether or not to be commissioned, number of customers held, or qualifications. The lead buyer behavior data further includes information on at least one of lead purchase history information, purchase lead feedback information, number of times a lead system is used for a certain period, lead searching history, lead inquiry history, or preferred lead information.

According to an embodiment of the present invention, the lead seller data includes lead seller profile data and lead seller behavior data. The lead seller profile data further includes information on at least one of a lead seller’s name, photo, age, area of activity, field of expertise, field of sales qualification, field of interest, whether or not to be commissioned, number of customers held, or qualifications. The lead seller behavior data further includes information on at least one of lead application activity information, sell history information, or sell lead feedback information.

According to an embodiment of the present invention, the purchase lead feedback information further includes a degree of satisfaction with a purchase lead input from a lead buyer and a degree of satisfaction with a purchase lead seller.

According to an embodiment of the present invention, the method for recommending business opportunity information includes, based on the learning model, predicting a degree of lead association between a purchasing lead, of which a degree of satisfaction with the purchasing lead of the predetermined lead buyer is equal to or higher than a predetermined reference value, and each lead data on sale; and based on the learning model, predicting a degree of lead seller association between lead seller data, of which a degree of satisfaction with the purchase lead seller of the predetermined lead buyer is equal to or higher than a predetermined reference value, and the lead seller data related to each lead on sale.

According to an embodiment of the present invention, the method for recommending business opportunity information further includes acquiring at least one of a lead preference and a lead system stay period, for each lead data on sale. The lead preference represents a value calculated based on at least one of the number of inquiries and the number of preference indications obtained based on an external input. The lead system stay period represents a time duration elapsed since the lead data was first uploaded to the lead system.

According to an embodiment of the present invention, the method for recommending business opportunity information further include generating a second lead recommendation list including at least one lead data on sale, by rearranging the first lead recommendation list, based on at least one of the degree of lead association, the degree of lead seller association, the lead preference, and the lead system stay period for the first lead recommendation list.

Further, according to an embodiment of the present invention, provided is a computer-readable recording medium in which a program for performing the method is recorded.

Further, according to an embodiment of the present invention, a business opportunity information recommendation server comprises a data acquisition module for obtaining lead data, lead buyer data, lead seller data, the lead being product or service-related business opportunity information for a customer, based on an external input; a learning module for generating a learning model by deep learning based on the lead data, the lead buyer data, the lead seller data; a prediction module for predicting, based on the learning model, a degree of association between a lead buyer and the lead, representing a purchasing possibility of a predetermined lead buyer for each lead data on sale; and a recommendation module for generating a first lead recommendation list including at least one lead data on sale, the first lead recommendation list being arranged based on the degree of association between the lead buyer and the lead for the predetermined lead buyer.

According to an embodiment of the present invention, the learning module further includes a vector generation module for generating a lead feature vector, a lead buyer feature vector, and a lead seller feature vector, including at least one feature vector representing each attribute value respectively, based on the lead data, the lead buyer data, and the lead seller data; and a learning model module for learning a degree of association between the lead buyer and the lead, based on the lead feature vector, the lead buyer feature vector, and the lead seller feature vector.

According to an embodiment of the present invention, the learning model module is configured to learn more about at least one of a degree of lead seller association representing a similar sales pattern between the lead seller data and a degree of lead association representing a similar sales pattern between the lead data, based on the lead feature vector, the lead buyer feature vector, and the lead seller feature vector.

According to an embodiment of the present invention, the lead data includes information on at least one of lead type, detailed information for each lead type, desired lead amount, customer name, customer age, customer gender, customer marital status, customer address, customer phone number, desired contact time of customer, customer budget, level of customer’s purchasing intention, customer’s expected purchasing time, or lead seller information.

According to an embodiment of the present invention, the lead buyer data includes lead buyer profile data and lead buyer behavior data. The lead buyer profile data further includes information on at least one of a lead buyer’s name, photo, age, area of activity, field of expertise, field of sales qualification, field of interest, whether or not to be commissioned, number of customers held, or qualifications. The lead buyer behavior data further includes information on at least one of lead purchase history information, purchase lead feedback information, number of times a lead system is used for a certain period, lead searching history, lead inquiry history, or preferred lead information.

According to an embodiment of the present invention, the lead seller data includes lead seller profile data and lead seller behavior data. The lead seller profile data further includes information on at least one of a lead seller’s name, photo, age, area of activity, field of expertise, field of sales qualification, field of interest, whether or not to be commissioned, number of customers held, or qualifications. The lead seller behavior data further includes information on at least one of lead application activity information, sell history information, or sell lead feedback information.

According to an embodiment of the present invention, the purchase lead feedback information further includes a degree of satisfaction with a purchase lead input from a lead buyer and a degree of satisfaction with a purchase lead seller.

According to an embodiment of the present invention, the prediction module is configured to predict, based on the learning model, a degree of lead association between a purchasing lead, of which a degree of satisfaction with the purchasing lead of the predetermined lead buyer is equal to or higher than a predetermined reference value, and each lead data on sale; and predict, based on the learning model, a degree of lead seller association between lead seller data, for which a degree of satisfaction with the purchase lead seller of the predetermined lead buyer is equal to or higher than a predetermined reference value, and the lead seller data related to each lead on sale.

According to an embodiment of the present invention, the data acquisition module is further configured to obtain at least one of a lead preference and a lead system stay period, for each lead data on sale, wherein the lead preference represents a value calculated based on at least one of the number of inquiries and the number of preference indications obtained based on an external input, and the lead system stay period represents a time duration elapsed since the lead data was first uploaded to the lead system.

According to an embodiment of the present invention, the recommendation module is further configured to generate a second lead recommendation list including at least one lead data on sale, by means of rearranging the first lead recommendation list, based on at least one of the degree of lead association, the degree of lead seller association, the lead preference, and the lead system stay period for the first lead recommendation list.

### Advantageous Effects

According to the present invention, a lead system for selling a lead, the lead including product or service-related sales opportunity information for a customer, makes it possible to recommend the lead with a higher degree of association by predicting a degree of association between a predetermined lead buyer and the lead, indicating a purchasing possibility for each lead data on sale by the lead buyer, based on a learning model for deep learning lead data, lead buyer data, and lead seller data for the lead, the lead including the product or service-related sales opportunity information for customers. Further, according to the present invention, it is possible to generate a recommended lead list more optimized for a lead buyer, by rearranging the recommended lead list based on at least one of purchase lead feedback information, preferred lead information, and a time duration of staying in the lead system of a predetermined lead buyer. As such, the lead sales in the lead system can be further promoted, thereby activating use of the lead system.

### BRIEF DESCRIPTION OF THE DRAWINGS

FIG. 1 illustrate an example of a schematic configuration of a lead system according to an embodiment of the present invention.

FIG. 2 is a schematic diagram of an example of a lead recommendation method according to an embodiment of the present invention.

FIG. 3 is a more detailed diagram of an example of a lead recommendation method according to an embodiment of the present invention.

FIG. 4 is a schematic block diagram of a lead server according to an embodiment of the present invention.

FIG. 5 is a schematic flowchart of a lead recommendation method according to an embodiment of the present invention

### MODE FOR CARRYING OUT THE INVENTION

Hereinafter, preferred embodiments of the present disclosure will be described in detail with reference to the accompanying drawings. Throughout the drawings, like or same reference numerals refer to like or same elements and the size of each component therein may be exaggerated or reduced for better clarity of description.

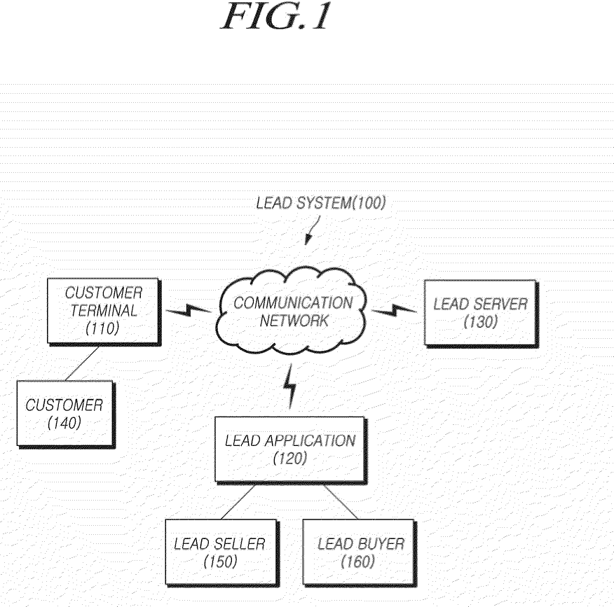

FIG. 1 illustrate an example of a schematic configuration of a lead system according to an embodiment of the present invention.

According to an embodiment of the present invention, a lead system 100 includes a customer terminal 110, a lead application 120 and a lead server 130.

The lead application 120 registers a lead, which is product or service-related business opportunity information for a customer, to the lead server 130 based on an external input from a lead seller 150.

The lead seller 150 includes a salesperson and at least one customer who wants to purchase a certain product or service. The salesperson may identify the customer’s purchasing needs (business opportunity information, i.e., lead) for other products or services other than the product or service handled by the salesperson during a sales activity such as e.g., a consultation with the customer. The lead seller 150 may provide a business opportunity to another salesperson (e.g., lead buyer 160) handling the other product or service, by sharing the lead with the other salesperson through the lead system 100. The customer may be provided with a sales opportunity from another salesperson handling the corresponding product or service in a time-efficient manner, by sharing the lead for the purchase needs for the product or service through the lead system 100.

Lead data may include information on at least one of lead type, detailed information by lead type, desired lead amount, customer name, customer age, customer gender, customer marital status, customer address, customer phone number, customer’s desired contact time, customer budget, customer’s purchasing intention level, customer’s expected purchasing time, or lead seller information. However, it would be apparent to those skilled in the art that the disclosure is not limited thereto, and the lead information may further include other business opportunity information. Further, it would be also apparent to an expert skilled in the art that the lead type may include car purchase, real estate purchase, car rental, real estate rental, insurance purchase, real estate tax consulting or the like, but it may further include various transaction types for various products or services. The detailed information for each lead type may include detailed information on various transaction types for the corresponding product or service. For example, in case where the lead type is of car purchase, the detailed information for each lead type may include information on used cars or new cars, information on domestic or foreign cars, and the like. For example, in case where the lead type is of tax consulting, the detailed information for each lead type may include taxable real estate and tax items. The level of customer’s purchase intention may indicate the level of customer’s purchasing intention for the product or service related to the lead, determined by the lead seller 150. The level of the customer’s purchasing intention may be expressed by dividing into preset steps, but it would be apparent to those skilled in the art that it is not limited thereto and may be expressed in various ways.

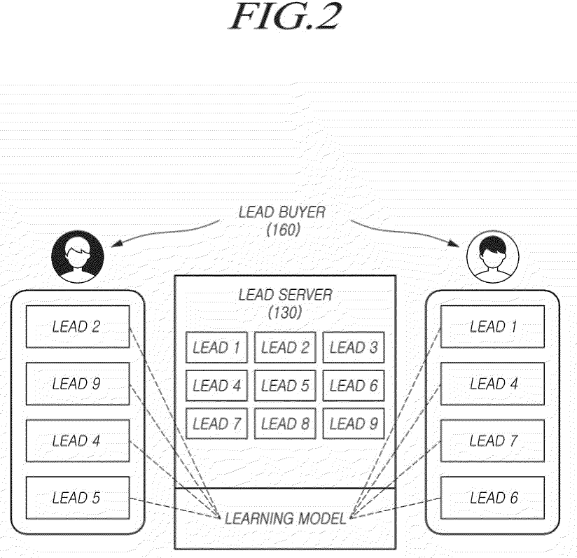

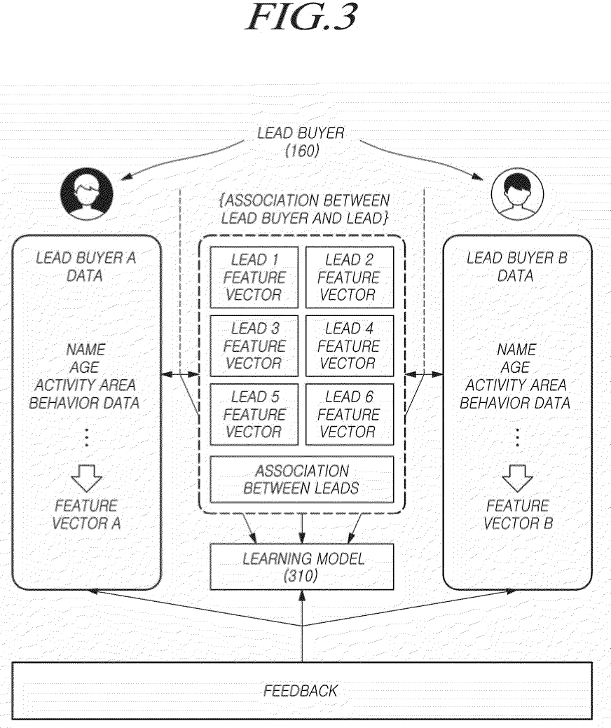

The lead server 130 registers the lead data obtained from the lead application 120 in a database. Further, the lead server 130 provides the lead application 120 with at least one predetermined lead data in the database in order to output to the lead buyer 160. The lead server 130 may recommend the at least one predetermined lead data to provide the same to the lead application 120. A method of recommending a lead by the lead server 130 will be described later with reference to FIGS. 2 and 3.

The lead application 120 receives from the lead buyer 160 a purchase request for a purchase lead of at least one predetermined lead provided from the lead server 130. Using this procedure, the lead buyer 160 attempts to purchase the purchase lead and sell the corresponding product or service to a customer obtained through the purchase lead. Further, when selling of the product or service related to the purchase lead is completed, the lead application 120 receives the completion of selling of the product or service related to the purchase lead from the lead buyer 160.

Based on an external input from the customer 140 in the process of registering the lead in the lead server 130, the customer terminal 110 receives the customer’s consent to registration of personal information, receives an approval of registration of the lead data, and receives a sell confirmation when the selling of the product or service related to the purchase lead is completed.

When selling of the product or service related to the purchase lead is completed, the lead server 130 obtains the sell confirmation from the customer terminal 110 and registers the sell confirmation for the purchase lead in the lead server 130. The lead server 130 manages lead transaction data for each lead data as a database. The lead transaction data may include information on at least one of purchase date, purchase amount, purchase lead feedback information, lead preference, or lead system stay period. The purchase lead feedback information includes information on a degree of satisfaction with the purchase lead and the lead seller input from the lead buyer, a degree of satisfaction with the lead buyer input from the lead seller, a degree of satisfaction with the lead buyer input from the customer, or a degree of satisfaction with the lead seller input from the customer. The lead preference represents a value calculated based on at least one of the number of inquiries and the number of preference indications, obtained based on an external input in the lead system 100 until transaction of the lead is completed. The number of preference indications may indicate the number of obtaining users’ preference indications such as e.g., ‘Like’ obtained based on external input.

As described above, the lead system 100 generally perform the steps of registering the lead from the lead seller 150, purchasing a specific lead (purchase lead) by the lead buyer 160, and completing and confirming the selling of the corresponding product or service to the customer related to the purchase lead.

FIG. 2 schematically illustrates a lead recommendation method according to an embodiment of the present invention.

Based on a learning model obtained by deep learning the lead data, the lead buyer data, and the lead seller data, the lead server 130 predicts a degree of association between the lead buyer indicating a purchasing possibility of a predetermined lead buyer 160 for each lead data on sale and the lead, thereby recommending a lead having a relatively higher association to the predetermined lead buyer 160.

Further, the lead server 130 may rearrange the recommended lead list based on at least one of the purchase lead feedback information, the lead preference of each lead data, and the lead system stay period of a predetermined lead buyer 160, thereby generating a list of recommended leads more optimized for the lead buyer. The lead server 130 uses the purchase lead feedback information to rearrange the recommended lead list, thereby prioritizing the lead data having the same or similar feature as the lead and the lead seller with high satisfaction in previous purchases of a predetermined lead buyer 160 so as to recommend the same to the predetermined lead buyer 160.

FIG. 3 shows a more detailed diagram of an example of a lead recommendation method according to an embodiment of the present invention.

The lead server 130 generates a learning model 310 through deep learning, based on the lead data, the lead buyer data, and the lead seller data.

The lead data includes information on at least one of lead type, detailed information for each lead type, desired lead amount, customer name, customer age, customer gender, customer marital status, customer address, customer phone number, desired contact time to customer, customer budget, level of customer’s purchasing intention, customer’s expected purchasing time, or lead seller information.

The lead buyer data includes lead buyer profile data and lead buyer behavior data. The lead buyer profile data further includes information on at least one of a lead buyer’s name, photo, age, area of activity, field of expertise, field of sales qualification, field of interest, whether or not to be commissioned, number of customers held, or qualifications. The lead buyer behavior data further includes information on at least one of lead purchase history information, purchase lead feedback information, number of times a lead system is used for a certain period, lead searching history, lead inquiry history, or preferred lead information. The purchase lead feedback information includes a degree of satisfaction with a purchase lead input from a lead buyer and a degree of satisfaction with a purchase lead seller.

The lead seller data includes lead seller profile data and lead seller behavior data. The lead seller profile data further includes information on at least one of a lead seller’s name, photo, age, area of activity, field of expertise, field of sales qualification, field of interest, whether or not to be commissioned, number of customers held, or qualifications. The lead seller behavior data further includes information on at least one of lead application activity information, sell history information, or sell lead feedback information.

The lead server 130 generates a lead feature vector, a lead buyer feature vector, and a lead seller feature vector, including at least one feature vector representing each attribute value respectively, based on the lead data, the lead buyer data, and the lead seller data. Based on the lead feature vector, the lead buyer feature vector, and the lead seller feature vector, the lead server 130 generates a learning model 310 for learning a degree of association between the lead buyer and the lead, indicating purchasing possibility between the lead data and the lead buyer data.

Further, the learning model 310 of the lead server 130 further performs learning of at least one of a degree of association of lead sellers indicating a similar sales pattern between the lead seller data and a degree of lead association indicating a similar sales pattern between the lead data, based on the lead feature vector, the lead buyer feature vector, and the lead seller feature vector. According to an embodiment of the present invention, when the lead seller feature vectors are similar to each other, it may be considered that the sales patterns are similar between the lead seller data, but it would be apparent to those skilled in the art that there may be envisaged various other methods capable of determining similar sales patterns. In addition, according to an embodiment of the present invention, when the lead feature vectors are similar to each other, it may be considered that the sales patterns are similar between the lead data, but it would be also apparent to those skilled in the art that there may be envisaged various other methods capable of determining similar sales patterns.

Based on the learning model 310, the lead server 130 predicts a degree of association between the lead buyer and the lead representing a purchasing possibility of a predetermined lead buyer 160 for each lead data on sale. Further, the lead server 130, based on the learning model 310, predicts a degree of lead association between a purchasing lead, of which satisfaction with the purchase lead of a predetermined lead buyer 160 is equal to or higher than a predetermined reference value, and each lead data on sale. Further, based on the learning model 310, the lead server 130 predicts a degree of lead seller association between the lead seller data, of which satisfaction with the purchasing lead seller of a predetermined lead buyer 160 is equal to or higher than a predetermined reference value, and the lead seller data related to each lead on sale.

The lead server 130 generates a first lead recommendation list including at least one lead data on sale, arranged in the order of the higher degree of association between the lead buyer and the lead, for a predetermined lead buyer 160.

The lead server 130 generates a second lead recommendation list including at least one lead data on sale rearranged from the first lead recommendation list, using at least one of the lead seller association, the lead preference, and the lead system stay period. The lead preference indicates a value calculated based on at least one of the number of users’ inquiries and the number of users’ preference indications, obtained based on an external input. The lead system stay period may represent the time elapsed since the lead data was first uploaded to the lead system.

For example, the lead server 130 may generate the second lead recommendation list by raising the priority of lead data having a short stay period in the lead system or having a high lead preference. Alternatively, the lead server 130 may generate the second lead recommendation list by raising the priority of lead data having the same or similar features as the lead and the lead seller having high satisfaction with previous purchases of the predetermined lead buyer.

According to the present embodiment, the lead server 130 of the lead system 100 makes it possible to, based on the learning model performing deep learning of the lead data, the lead buyer data, and the lead seller data, predict a degree of association between the lead buyer and the lead representing a purchasing possibility of a predetermined lead buyer 160 for a predetermined lead buyer 160 for each lead data on sale, thereby recommending a lead having a higher degree of association to the lead buyer. Further, according to the present embodiment, the lead server 130 may rearrange the recommended lead list based on at least one of the purchase lead feedback information, the preferred lead information, and the lead system stay period of the predetermined lead buyer, so that it can generate and provide a lead recommendation list more optimized to the lead buyer 160. Using this lead system makes it possible to more promote lead sales in the lead system 100 and make the lead system 100 even more activated.

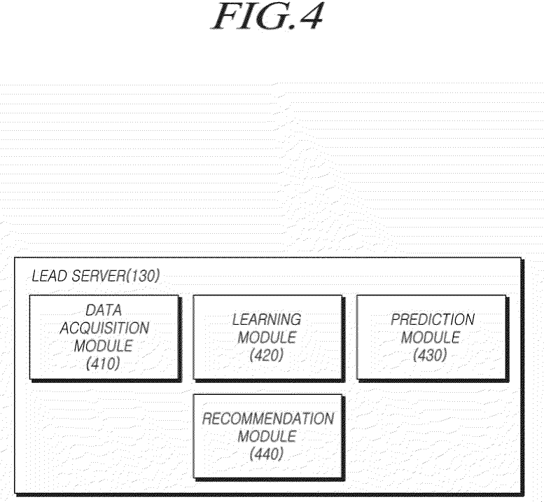

FIG. 4 is a schematic block diagram of a lead server according to an embodiment of the present invention.

A lead server 130 according to an embodiment of the present invention includes a data acquisition module 410, a learning module 420, a prediction module 430 and a recommendation module 440.

The data acquisition module 410 may acquire, based on an external input, the lead data, the lead buyer data, and the lead seller data, which are business opportunity information related to a product or service for a customer. The data acquisition module 410 may further acquire at least one of a lead preference or a lead system stay period for each lead data on sale. The lead preference may indicate a value calculated based on at least one of the number of inquiries and the number of preference indications obtained based on external inputs. The lead system stay period may indicates the time elapsed since the lead data was first uploaded to the lead system.

Based on the lead data, the lead buyer data, and the lead seller data, the learning module 420 may perform deep learning to generate a learning model. According to the present embodiment, the learning module 420 may use at least one of a machine learning algorithm such as e.g., random forest, DNN (Deep Neural Network), CNN (Convolutional Neural Networks), RNN (Recurrent Neural Network), RBM (Restricted Boltzmann Machine), DBN (Deep Belief Network) or DQN (Deep Q-Networks), but it will be apparent to those skilled in the art that the present disclosure is not limited thereto.

The learning module 420 may include a vector generator (not shown) and a learning model module (not shown).

The vector generator, based on the lead data, the lead buyer data, and the lead seller data, may generate a lead feature vector, a lead buyer feature vector, and a lead seller feature vector. The lead feature vector, the lead buyer feature vector, and the lead seller feature vector include at least one feature vector indicating each attribute value respectively.

The learning model module may learn about a degree of association between the lead buyer and the lead indicating a purchasing possibility between the lead data and the lead buyer data, based on the lead feature vector, the lead buyer feature vector, and the lead seller feature vector. The learning model module may, based on the lead feature vector, the lead buyer feature vector, and the lead seller feature vector, learn more about at least one of a degree of lead seller association indicating a similar sales pattern between the lead seller data and a degree of lead association indicating a similar sales pattern between the lead data.

Based on the learning model, the prediction module 430 may predict a degree of association between the lead buyer and the lead representing a purchasing possibility of a predetermined lead buyer for respective lead data on sale. Based on the learning model, the prediction module 430 may further predict a lead association between a purchase lead having a satisfaction with the purchase lead of a predetermined lead buyer, being greater than or equal to the predetermined reference value and the respective lead data on sale. Based on the learning model, the prediction module 430 may further predict a degree of lead seller association between the lead seller data, of which satisfaction of the predetermined lead buyer with the purchased lead seller is greater than or equal to a predetermined reference value, and the lead seller data related to each lead on sale.

The recommendation module 440 may generate a first lead recommendation list including at least one lead data on sale, which is arranged in an order of higher association between the lead buyer and the lead for a predetermined lead buyer. The recommendation module 440 may further generate a second lead recommendation list including at least one lead data on sale, by means of rearranging the first lead recommendation list using at least one of the lead association, the lead seller association, the lead preference, or the lead system stay period.

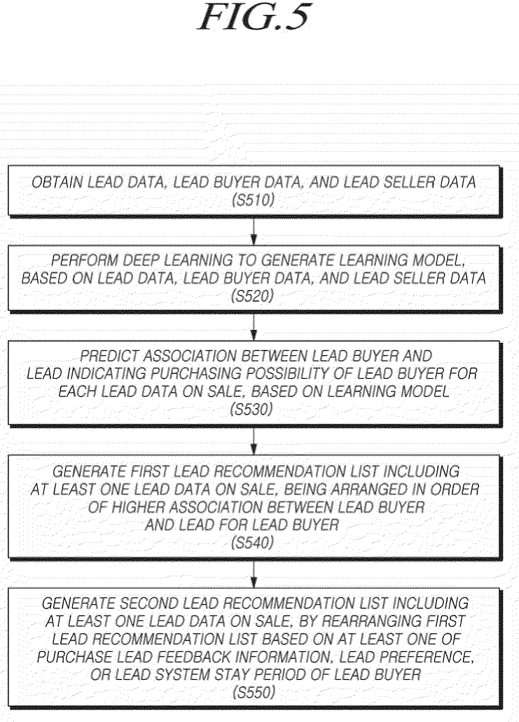

FIG. 5 is a schematic flow chart of a lead recommendation method according to an embodiment of the present invention.

In operation S510, the lead server 130 obtains lead data, lead buyer data, and lead seller data, which are business opportunity information related to products or services for customers, based on an external input.

In operation S520, based on the lead data, the lead buyer data, and the lead seller data, the lead server 130 performs deep learning to generate a learning model. More specifically, based on the lead data, the lead buyer data, and the lead seller data, the lead server 130 generate a lead feature vector, a lead buyer feature vector, and a lead seller feature vector, including at least one feature vector indicating each attribute value, respectively. Further, based on the lead feature vector, the lead buyer feature vector, and the lead seller feature vector, the lead server 130 generates a learning model that learns about a degree of association between the lead buyer and the lead, representing a purchasing possibility between the lead data and the lead buyer data.

In operation S530, the lead server 130 predicts a degree of association between the lead buyer and the lead indicating a purchasing possibility of a predetermined lead buyer for each lead data on sale, based on the learning model.

In operation S540, the lead server 130 generates a first lead recommendation list including at least one lead data on sale, which is arranged in the order of higher association between the lead buyer and the lead for the predetermined lead buyer.

In operation S550, the lead server 130 may generate a second lead recommendation list including at least one lead data on sale, by rearranging the first lead recommendation list based on at least one of the purchase lead feedback information, the lead preference, or the lead system stay period of a predetermined lead buyer. The preference may represent a value calculated based on at least one of the number of users’ inquiries and the number of users’ preference indications obtained based on external inputs. The lead system stay period may represent the time elapsed since the lead data was first uploaded to the lead system.

The lead server 130 may use the purchase lead feedback information to rearrange the lead recommend list, thereby generating the second lead recommendation list by increasing the priority of the lead data having substantially the same or similar features as the leads and the lead sellers with high satisfaction in previous purchases of the predetermined lead buyer. To this end, the lead server 130 may perform (not shown) a further learning of at least one of a degree of lead seller association indicating a similar sales pattern between the lead seller data and a degree of lead associations indicating a similar sales pattern between the lead data, based on the lead feature vector, the lead buyer feature vector, and the lead seller feature vector. Based on the learning model, the lead server 130 may predict (not shown) a degree of lead association between the purchase lead having satisfaction with the purchase lead of the predetermined lead buyer, that is equal to or higher than a predetermined reference value, and each lead data on sale. Further, based on the learning model, the lead server 130 may predict (not shown) a lead seller association between the lead seller data, of which satisfaction with the purchase lead seller of the predetermined lead buyer is higher than or equal to the predetermined reference value, and the lead seller data related to each lead on sale.

While preferred embodiments of the disclosure have been described in detail heretofore, the scope of the present invention is not limited thereto, and various modifications and equivalent other embodiments are possible. Therefore, the true technical scope of protection of the present invention shall be defined by the appended claims.

For example, a device according to an example embodiment of the disclosure may include a bus coupled to units of each apparatus or device as illustrated, at least one processor operatively coupled to the bus, and a memory coupled to the bus to store instructions, received messages, or generated messages, and coupled to the at least one processor to perform the aforementioned instructions.

Further, a system according to the present invention may be implemented with computer-readable codes on a computer-readable recording medium. The computer-readable recording medium may include any kinds of recording devices in which data readable by a computer system is stored. The computer-readable recording medium may include a magnetic storage medium (e.g., ROM, floppy disk, hard disk, etc.) and an optical reading medium (e.g., CD-ROM, DVD, etc.). The computer-readable recording medium may be distributed over a network-connected computer system to store and execute computer-readable codes in a distributed manner.

1] A business opportunity information recommendation server, comprising:
a data acquisition module for obtaining lead data, lead buyer data, lead seller data, the lead being product or service-related business opportunity information for a customer, based on an external input;
a learning module for generating a learning model by deep learning based on the lead data, the lead buyer data, the lead seller data;
a prediction module for predicting, based on the learning model, a degree of association between a lead buyer and the lead, representing a purchasing possibility of a predetermined lead buyer for each lead data on sale; and
a recommendation module for generating a first lead recommendation list including at least one lead data on sale, the first lead recommendation list being arranged based on the degree of association between the lead buyer and the lead for the predetermined lead buyer.

2] The business opportunity information recommendation server according to claim 1, wherein the learning module includes:
a vector generation module for generating a lead feature vector, a lead buyer feature vector, and a lead seller feature vector, including at least one feature vector representing each attribute value respectively, based on the lead data, the lead buyer data, and the lead seller data; and
a learning model module for learning a degree of association between the lead buyer and the lead, based on the lead feature vector, the lead buyer feature vector, and the lead seller feature vector.

3] The business opportunity information recommendation server according to claim 2, wherein the learning model module learns more about at least one of a degree of lead seller association representing a similar sales pattern between the lead seller data and a degree of lead association representing a similar sales pattern between the lead data, based on the lead feature vector, the lead buyer feature vector, and the lead seller feature vector.

4] The business opportunity information recommendation server according to claim 3, wherein the lead data includes information on at least one of lead type, detailed information for each lead type, desired lead amount, customer name, customer age, customer gender, customer marital status, customer address, customer phone number, desired contact time of customer, customer budget, level of customer’s purchasing intention, customer’s expected purchasing time, or lead seller information.

5] The business opportunity information recommendation server according to claim 3,
wherein the lead buyer data includes lead buyer profile data and lead buyer behavior data;
wherein the lead buyer profile data further includes information on at least one of a lead buyer’s name, photo, age, area of activity, field of expertise, field of sales qualification, field of interest, whether or not to be commissioned, number of customers held, or qualifications; and
wherein the lead buyer behavior data further includes information on at least one of lead purchase history information, purchase lead feedback information, number of times a lead system is used for a certain period, lead searching history, lead inquiry history, or preferred lead information.

6] The business opportunity information recommendation server according to claim 3,
wherein the lead seller data includes lead seller profile data and lead seller behavior data,
wherein the lead seller profile data further includes information on at least one of a lead seller’s name, photo, age, area of activity, field of expertise, field of sales qualification, field of interest, whether or not to be commissioned, number of customers held, or qualifications, and
wherein the lead seller behavior data further includes information on at least one of lead application activity information, sell history information, or sell lead feedback information.

7] The business opportunity information recommendation server according to claim 5, wherein the purchase lead feedback information further includes a degree of satisfaction with a purchase lead input from a lead buyer and a degree of satisfaction with a purchase lead seller.

8] The business opportunity information recommendation server according to claim 7, wherein the prediction module,
based on the learning model, further predicts a degree of lead association between a purchasing lead, of which satisfaction with the purchasing lead of the predetermined lead buyer is equal to or higher than a predetermined reference value, and each lead data on sale; and
based on the learning model, further predict a degree of lead seller association between lead seller data, of which satisfaction with the purchase lead seller of the predetermined lead buyer is equal to or higher than a predetermined reference value, and the lead seller data related to each lead on sale.

9] The business opportunity information recommendation server according to claim 8,
wherein the data acquisition module further obtains at least one of a lead preference and a lead system stay period for each lead data on sale,
wherein the lead preference represents a value calculated based on at least one of the number of inquiries and the number of preference indications obtained based on an external input, and
wherein the lead system stay period represents a time duration elapsed since the lead data was first uploaded to the lead system.

10] The business opportunity information recommendation server according to claim 9, wherein the recommendation module further generates a second lead recommendation list including at least one lead data on sale, by rearranging the first lead recommendation list, using at least one of the degree of lead association, the degree of lead seller association, the lead preference, and the lead system stay period.

11] A method for recommending business opportunity information, comprising the steps of:
obtaining lead data, lead buyer data, lead seller data, the lead being product or service-related business opportunity information for a customer, based on an external input;
generating a learning model by deep learning based on the lead data, the lead buyer data, the lead seller data;
based on the learning model, predicting a degree of association between a lead buyer and the lead representing a purchasing possibility of a predetermined lead buyer for each lead data on sale; and
generating a first lead recommendation list including at least one lead data on sale, being arranged based on the degree of association between the lead buyer and the lead for the predetermined lead buyer.

12] The method for recommending business opportunity information according to claim 11, wherein the step of generating the learning model further includes the steps of:
generating a lead feature vector, a lead buyer feature vector, and a lead seller feature vector, including at least one feature vector representing each attribute value respectively, based on the lead data, the lead buyer data, and the lead seller data; and
generating a learning model for learning about a degree of association between the lead buyer and the lead, based on the lead feature vector, the lead buyer feature vector, and the lead seller feature vector.

13] The method for recommending business opportunity information according to claim 12, wherein the step of generating the learning model further includes learning about at least one of a degree of lead seller association representing a similar sales pattern between the lead seller data and a degree of lead association representing a similar sales pattern between the lead data, based on the lead feature vector, the lead buyer feature vector, and the lead seller feature vector.

14] A computer-readable recording medium in which a program for performing the method according to claim 11 is recorded.
